(19) United States
(12) Patent Application Publication
(10) Pub. No.: US 2002/0109991 A1
(43) Pub. Date: Aug. 15, 2002

(54) Mechanic's creeper with work lighting

(76) Inventor: Andrew Jackson Alsup, Mooresville, NC (US)

Correspondence Address: DOUGHERTY & CLEMENTS, TWO FAIRVIEW CENTER, 6230 FAIRVIEW ROAD, SUITE 400, CHARLOTTE, NC, 28210, US

(21) Appl. No.: 09/781,024

(22) Filed: Feb. 9, 2001

(51) Int. Cl. F21W 131/402; F 21W 1 1/00

(52) U.S. Cl. 362/253; 362/225

(57) ABSTRACT

The invention consists of an improved automobile mechanic's creeper having built-in rechargeable lamps that are positioned with respect to the mechanic's body such that the undercarriage of the automobile being serviced is effectively illuminated without need for a separate illuminator thereby eliminating the problems concomitant with a separate illuminator.

### FIELD OF THE INVENTION

The present invention relates to an apparatus for illuminating work objects. More particularly, it relates to an apparatus for illuminating work objects on the underside of an automobile when work is performed on a low profile, wheeled platform used by automobile mechanics to position themselves at an appropriate work site under an automobile for effecting adjustments or repairs to said automobile.

### BACKGROUND OF THE INVENTION

Automobile mechanics often use a low profile, wheeled platform, known as a “creeper” to position themselves under an automobile in order to perform work on or make repairs to the automobile.

When using a creeper, the mechanic is generally supine, with the creeper supporting the mechanic's back. The device is positioned by manipulating the feet whereby the mechanic's weight is supported by the device and little effort is needed to adjust the mechanic's position with respect to the automobile undercarriage.

A mechanic effecting repairs or adjustments under an automobile, using a creeper is faced with the problem of adequately seeing his work. Illumination is generally provided by work lights which may be dry cell battery powered lanterns or incandescent “work lights” which feature an impact-resistant light bulb in a metal cage to minimize inadvertent damage to the bulb. Incandescent work lights generally are provided with a 20-foot power cord. Flourescent lamps are sometimes provided either with a dry cell battery, a rechargeable battery or a power cord. The mechanic, working in cramped tight quarters must manipulate required tools, required parts and additionally one of the cited illuminators. All these choices have disadvantages. Because it is inexpensive, a common choice is the incandescent work light. This device is also one of the most problematic. The cage that protects the bulb can be difficult to maneuver. In addition, the cage and bulb become hot enough to burn the mechanic's skin if contact is made and sometimes hot enough to exceed the kindling point of materials being handled. In all cases, the mechanic is forced to handle tools, materials needed to perform the task and manipulate the lamp. Aiming the lamp at the work is lamp dependent but is often clumsy and artistic resulting in frustration and lost productivity. Corded devices have the additional problems of cord tangling and constrained distance to an outlet. The mechanic using corded illuminators must often cope with hoses for pneumatic tools, gas hoses for welding and/or power cords for electrically powered tools.

### SUMMARY OF THE INVENTION

The invention consists of an improved automobile mechanic's creeper having built-in rechargeable lamps positioned with respect to the mechanic's body such that the problems with discrete lamps are substantially eliminated.

### OBJECTS OF THE INVENTION

The object of the invention is to provide an improved creeper having an illumination device that requires no separate handling thus permitting a mechanic to more productively perform a task.

Another object of the invention is to provide an improved creeper having an illumination device for an automobile mechanic that eliminates lost productivity due to power cord manipulation.

### BRIEF DESCRIPTION OF THE DRAWINGS

The foregoing and other objects will become more readily apparent by referring to the following detailed description and the appended drawing in which:

FIG. 1 shows a side view of a typical creeper according to prior art;

FIG. 2 shows a top view of the creeper of FIG. 1;

FIG. 3 shows a cross-section of the creeper of FIG. 1;

FIG. 4 shows a top view of the improved creeper according to this invention;

FIG. 5 shows a cross-section of the improved creeper of FIG. 4;

FIG. 6 shows a cross-section of the illuminator of the improved creeper; and,

FIG. 7 shows a cross-section of the improved creeper in its recharging mount.

### DETAILED DESCRIPTION

The present invention now will be described more fully hereinafter with reference to the accompanying drawings, in which a preferred embodiment of the invention is shown. This invention may, however, be embodied in many different forms and should not be construed as limited to the embodiment set forth herein; rather, this embodiment is provided so that this disclosure will be, thorough and complete, and will convey the scope of the invention fully to those skilled in the art. Like numbers refer to like elements throughout.

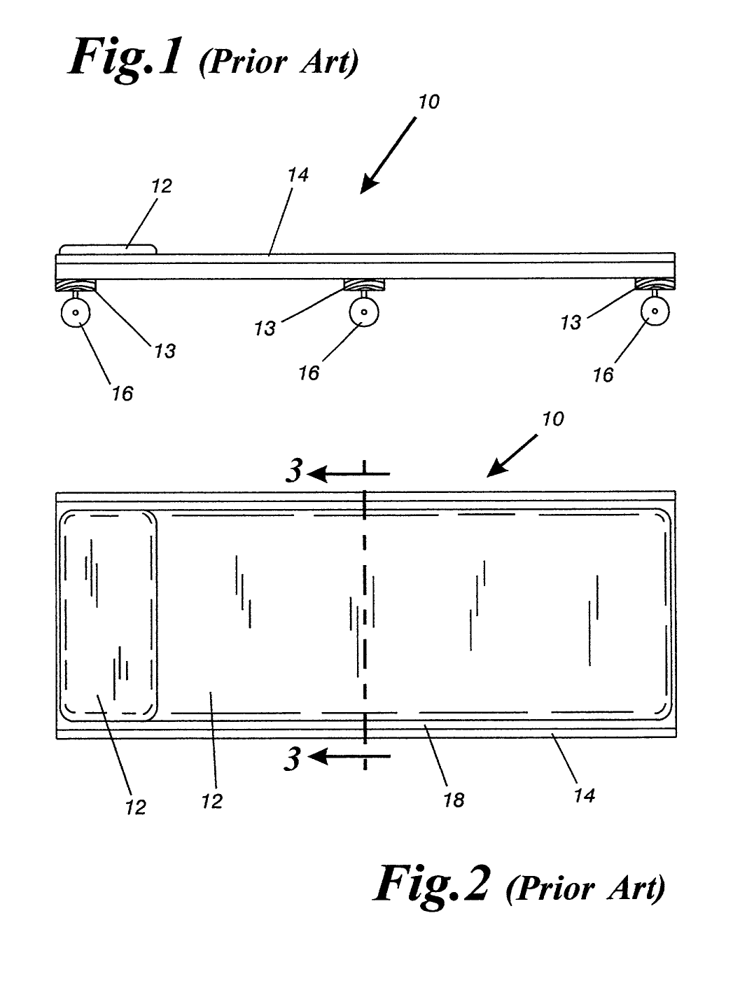

Referring to FIGS. 1 and 2, a typical mechanic's creeper 10 consists of a frame, preferably steel, having two longitudinal members 14 connected by three cross-members 13, with the cross-members 13 provided with a total of six casters 16. The frame supports a platform 18 that is typically plywood that has been finish-sanded and varnished. The platform 18 typically rests upon and is connected to the cross-members 13. Advantageously, a leatherette-covered foam-rubber pad 12 may be affixed to the platform 18. The foam pad 12 may have a thickened section that acts as a head rest.

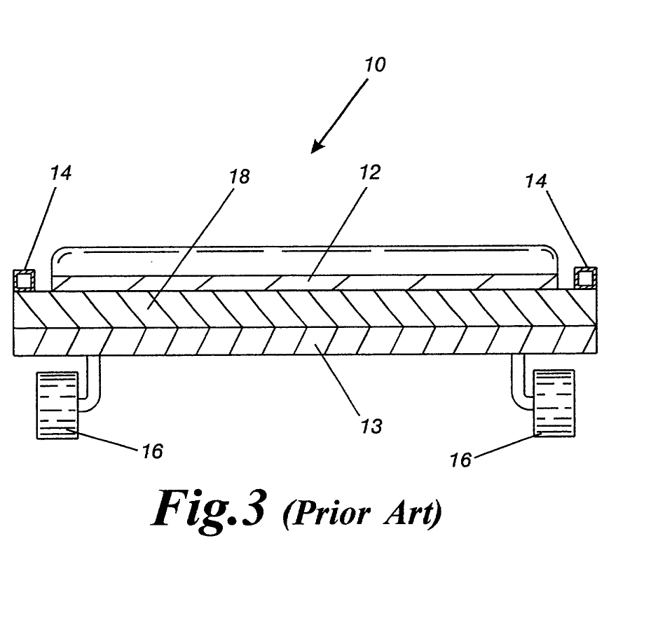

Referring to FIG. 3, the platform 18 is supported on three cross members 13 that also mount the casters 16. Longitudinal steel members 14 are bolted or otherwise attached to the cross members 13, through the platform 18. Padding 12, if any, is bonded to the platform 18.

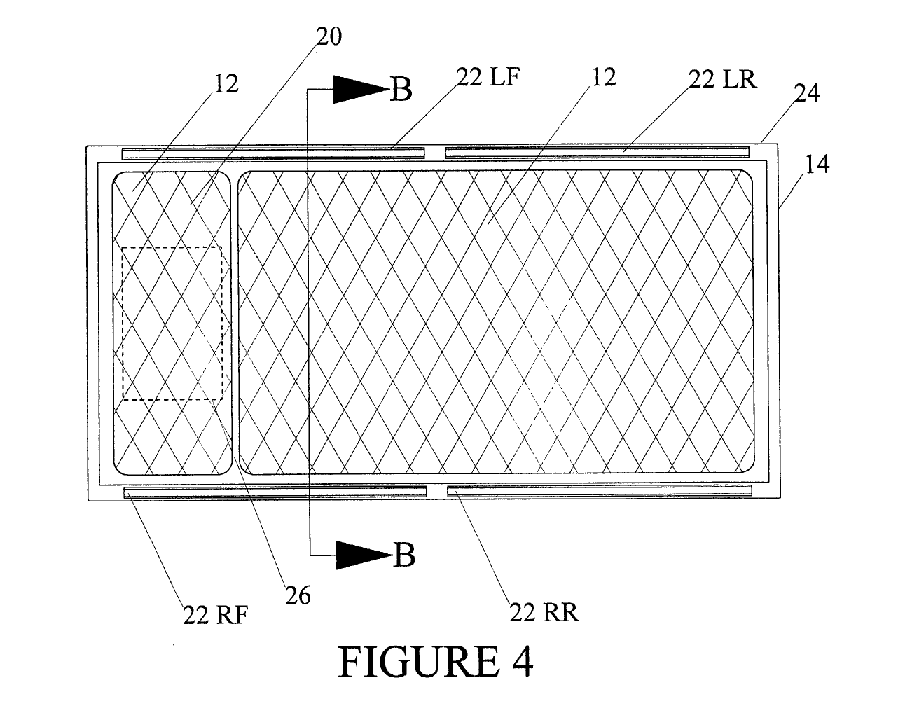

Referring to FIG. 4, the invented creeper differs from prior art creepers in the addition of task lighting. The task lighting is preferably provided by modifying the prior-art longitudinal frame members 14 to accept lighting elements 22 LF, 22 LR, 22 RF and 22 RR for the left-front, left-rear, right-front and right-rear lighting elements, respectively. The invented creeper also includes electrical components for powering the lighting elements 22 within a subassembly 26, including a rechargeable battery, a D.C. to A.C. converter, and a transformer electrically connected to the lighting elements 22. The lighting elements are preferably flourescent lamps, but other lamp technology may be used. Flourescent technology is preferred because this technology is currently the most efficient (up to 80-lumens/watt) and because the flourescent bulbs do not reach the high temperatures of incandescent bulbs.

Energy efficiency is desirable to increase battery life. A small temperature increase is desirable for mechanic comfort and workplace safety. Preferably, four lamp assemblies 24 are used, though the invention is operative with as few as one assembly. The lamp assemblies 24 are preferably placed within or on the top of longitudinal members 14, although, the lamp assemblies 24 may be placed at various locations about the creeper, and may even be placed under the creeper, facing downward such that light from the assemblies provides indirect lighting of the automobile undercarriage.

As mentioned above, power for the light assemblies 24 is provided by subassembly 26 that contains a rechargeable battery, a D. C. to A. C. converter and a transformer or equivalent for matching the voltage and current requirement of the lamp or lamps. Subassembly 26 is preferably located on the underside of the creeper, and is more preferably located within the headrest portion of the padding 12.

For purposes of recharging the battery within subassembly 26, there are two options for attaching the battery to a recharging power source. A direct contact recharger, using two metal contacts which may be plated with a corrosion-resistant metal (such as beryllium-copper or gold), may be used. Alternately, a magnetic coupler may be used so that the power attachment consists of a magnetic core that is packaged in a sturdy plastic. Preferably, the subassembly 26 has a male part that mates with a female part that is connected to house A. C. power, and oscillating magnetic fields from a primary coil in the female part couple energy from house power to a recharging battery pack in battery subassembly 26. Alternatively, any common electrical coupling means may be used to connect the battery containing subassembly 26 to the recharging unit.

The lamps are switched on and off by a switch or switches 40 packaged to be reached easily by the mechanic along the rear portion (near the headrest) of the creeper. Preferably, two switches are included so the operation is convenient for right handed and for left-handed mechanics. In this case, two single pole double throw switches 40 are used and wired so that either switch reverses the state of the lamp(s) when toggled. The switches 40 are electrically connected between the battery containing subassembly 26 and the light assemblies 24.

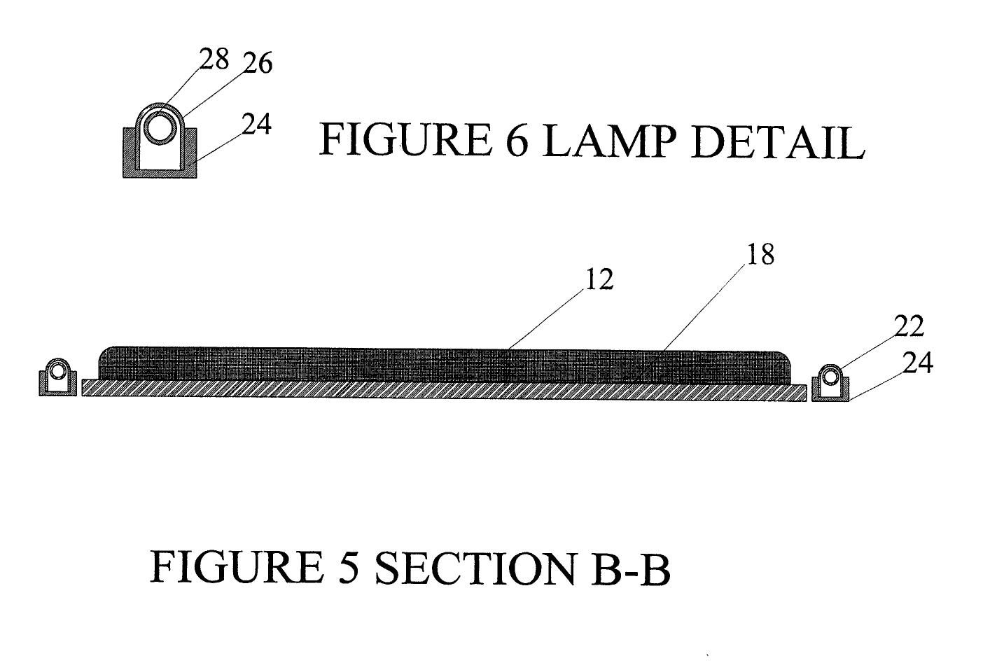

Referring to FIGS. 5 and 6, longitudinal frame member 24 is preferably modified to accept a lamp 28 and protective cover 26. The protective cover 26 may be fashioned of polymethyl methacrylate (Lucite ©) or any equivalent clear, rugged plastic or reinforced glass.

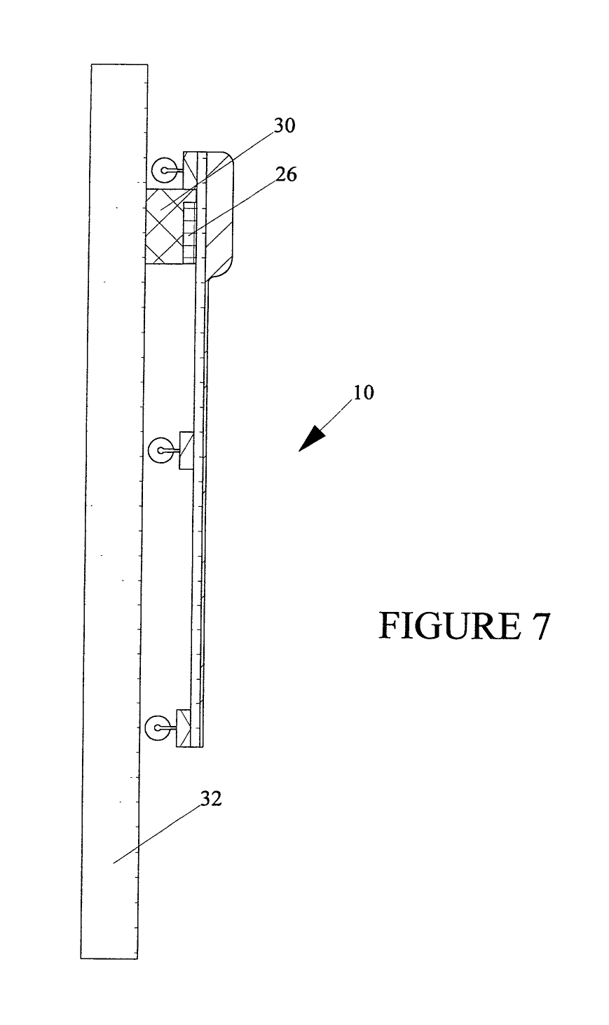

Referring to FIG. 7, a preferred method of recharging the invented creeper is by mounting the creeper on a wall for recharging. A voltage converter is attached to household power and may contain a recharging unit (in the alternative of metal recharging contacts) or simply house a primary transformer coil packaged around a female socket. In the later case, the recharger is contained in the battery subassembly 26. When the creeper is no longer in use by a mechanic, the creeper is simply mounted on the mating fixture for recharging.

### SUMMARY OF THE ACHIEVEMENT OF THE OBJECTS OF THE INVENTION

From the foregoing, it is readily apparent that I have invented an improved creeper having an illumination device that requires no separate handling thus permitting a mechanic to more productively perform a task and that additionally eliminates lost productivity caused by to power cord manipulation.

It is to be understood that the foregoing description and specific embodiments are merely illustrative of the best mode of the invention and the principles thereof, and that various modifications and additions may be made to the apparatus by those skilled in the art, without departing from the spirit and scope of this invention.

What is claimed is:

1. An improved automobile mechanic's creeper comprising:
a creeper;
at least one lamp mounted on said creeper for illuminating an automobile undercarriage proximate to said mechanic; and,
a power source mounted on said creeper and operatively connected to said at least one lamp for providing electrical power to said at least one lamp.

2. The apparatus recited in claim 1 wherein said at least one lamp is a flourescent lamp.

3. The apparatus recited in claim 1 wherein said power source comprises a rechargeable battery and a D. C. to A. C. converter to provide power consistent with said lamp.

4. The apparatus as recited in claim 3 wherein said power source additionally comprises a recharging circuit operatively connected to said rechargeable battery.

5. The apparatus as recited in claim 4 additionally comprising a mating means for attaching said recharging circuit to a wall-mounted recharging unit.

6. The apparatus as recited in claim 5 wherein said mating means is magnetic.

7. The apparatus as recited in claim 3 additionally comprising a mating means for attaching said recharging circuit to a wall-mounted recharging unit.

8. The apparatus as recited in claim 7 wherein said coupling consists of metallic contacts.
